(19) United States
(12) Patent Application Publication
(10) Pub. No.: US 2020/0297000 A1
(43) Pub. Date: Sep. 24, 2020

(54) ASEPTIC PROCESSING FOR FOOD AND BEVERAGES

(71) Applicant: NESTEC S.A., Vevey (CH)

(72) Inventors: Lu Wang, Dublin, OH (US); Dominick Damiano, Dublun, OH (US)

(21) Appl. No.: 15/779,582

(22) PCT Filed: Nov. 29, 2016
(86) PCT No.: PCT/EP2016/079079

§ 371 Date: May 29, 2018

Related U.S. Application Data
(60) Provisional application No. 62/262,747, filed on Dec. 3, 2015.

(51) Int. Cl. A23L 2/46; A23L 2/385; A23L 3/28; A23L 3/32; A23L 2/50; A23L 3/22; B65B 55/14; B65B 3/04; B65B 55/16

(52) U.S. Cl. CPC A23L 2/46; A23L 2/385; A23L 3/28; A23L 3/32; A23L 2/50; A23C 3/033; B65B 55/14; B65B 3/04; B65B 55/16; A23V 2002/00; A23L 3/22

(57) ABSTRACT

The present teachings provide an approach for energy efficient creation of dilute sterile fluids such as ready-to-drink beverages. To achieve such creation, a beverage processing apparatus may have a sterile liquid concentrate source connected to deliver sterile liquid concentrate and a sterile water source having an inlet connected to receive water and a cold water filter sterilizer connected to the inlet. The apparatus may also have a dilute fluid outlet and an aseptic mixing component. The aseptic mixing component may be interconnected between the sterile liquid concentrate source, the sterile water source and the dilute fluid outlet to: receive sterile liquid concentrate; receive sterile water; and to provide a dilute fluid.

### FIELD AND BACKGROUND

The present disclosure relates to aseptic processing of food and beverages and in particular but not exclusively to a sustainable and energy efficient approach for processing of food and/or beverages using an aseptic processing line.

In beverage production, a sterile beverage may be produced by a process of first creating a beverage by mixing a concentrate with water, and possibly other ingredients, and then sterilizing the beverage using a UHT (ultra-high temperature) sterilization process. In the alternative, a sterile beverage may be produced by combining ingredients directly without use of a concentrate, and then sterilizing the prepared beverage using a UHT sterilization process. Such approaches result in a sterile beverage that may be packaged for distribution and may provide for a sterile packaged beverage product shelf-life of several weeks or months. There are a variety of beverage products that today are processed through these UHT systems. Such products can be coffee drinks, tea drinks, juices, nectars, milk and flavored milk beverages, flavored waters, coffee creamers, nutritional drinks, enteral products, and the like. The drinks will contain ingredients such as coffee, tea, sweeteners, emulsifiers, stabilizers, fats and oils, milk, and other such ingredients. Such a beverage may be referred to as a ready-to-drink beverage in that the beverage does not require a further treatment such as dilution, brewing or infusion before consumption. Alternatively, the beverage may be sold or distributed as a concentrate for further dilution, where anywhere from one part to six parts of water are added by a consumer or foodservice operator to prepare the beverage to be ready for consumption.

The UHT process may typically have a pre-heat section to heat the product to an intermediate temperature, a final heating section to heat the product to its sterilization temperature, a hold tube to hold the product for a minimal amount of time at the sterilization temperature to sterilize it, a section to pre-cool the product, a sterile homogenizer (if needed), and final product cooling. Sterilization temperatures typically are in the range of 90 to 110 C for acid products (typically considered to be products with a pH less than 4.6), and are in the range of 130 to 147 C for low acid products (typically considered to be products with a pH more than 4.6). Such UHT systems can be set up with only indirect heating, or with direct heating (for example direct steam injection) to reach sterilization temperatures. If such direct heating is used, then there may typically also be included a vacuum flash chamber to remove from the product an amount of water that is equivalent to the amount of steam as condensed that was used to directly heat the product.

In food processing, a method and apparatus for aseptically dosing and preparing food materials is described in WO2014/011176.

In beverage production, U.S. Pat. No. 6,599,546 discusses a process and apparatus for in-line production of heat-processed beverages made from concentrate. The publication describes a system and apparatus for producing heat-pasteurized or sterilized beverages from concentrate. The system comprises heating a diluent and combining the first metered diluent stream with a metered stream of beverage concentrate to produce a primary reconstituted beverage solution. The system further provides combining the primary reconstituted beverage solution with a metered second diluent stream to produce a secondary reconstituted solution, wherein the second diluent stream is also directed from the heated diluent, but is cooled to provide direct heat transfer. Various additives may be provided to the beverage solution throughout the system based on their sensitivity to heat, pH and water solubility. This document focuses on attempts to improve efficiency of production and control over quality and amount of ingredients in the final beverage. As is discussed in this document, the efficiency aim of the document is apparent as being improvements in efficiency in performing heat-based pasteurization or sterilization of beverages. It is also apparent from this document that this discussion of efficiency aim is closely linked to control of dilution percentage by use of primary and secondary dilution stages.

WO2015/113035 discusses a non-thermal sterilization process for nutritional compositions. The process is described as including aseptically filtering a nutritional composition at room temperature prior to filling the nutritional composition into its packaged form,

### SUMMARY

The present teachings relate to use of an aseptic food or beverage processing line with reduced environmental impact. In some implementations, the teachings can provide a processing line that performs non-thermal sterilization of water and combines the sterilized water with sterile or sterilized ingredients or concentrate using aseptic connectors and fillers which provide an integrated aseptic food or beverage processing system. When performing sterilization of water according to the present teachings, the energy used in sterilization by passing the water through two sterile filters in series may be less than 1% of the energy input that would have been necessary to achieve sterilization by UHT thermal treatment. Also, in some examples consistent with the present teachings, the water to be sterilized before aseptic mixing with concentrate or other ingredients may itself contain other ingredients or may be an alternative diluent other than water.

Viewed from one perspective, there can be provided an apparatus comprising: a sterile liquid concentrate source; a non-thermal sterilizer connected to a diluent source; a dilute fluid outlet; and an aseptic mixing component connected: to the sterile liquid concentrate source to receive sterile liquid concentrate therefrom; to the non-thermal sterilizer to receive sterile diluent therefrom; and to the dilute fluid outlet to provide a dilute fluid thereto. Thereby a sterile mixture can be manufactured from a concentrate and a diluent using an energy efficient process for sterilization of the diluent while maintaining a sterility requirement for the resulting mixture.

Viewed from another perspective, there can be provided a beverage or food processing apparatus for dilution of a beverage or food concentrate, the apparatus comprising: a sterile liquid concentrate source connected to deliver sterile liquid concentrate; a sterile potable diluent source comprising an inlet connected to receive potable diluent and a cold filter sterilizer connected to the inlet; a dilute fluid outlet; and an aseptic mixing component connected: to the sterile liquid concentrate source to receive sterile liquid concentrate therefrom; to the sterile potable diluent source to receive sterile potable diluent therefrom; and to the dilute fluid outlet to provide a dilute fluid thereto. Thereby a sterile potable diluent can be produced in am energy efficient manner, while also providing controlled and maintained sterility through a process of using the diluent to dilute a sterile concentrate.

Viewed from a further perspective, there can be provided a method of diluting a food or beverage concentrate comprising: feeding a sterile liquid concentrate from a sterile liquid concentrate source; producing sterile water by non-thermal sterilization; and combining the sterile liquid concentrate and sterile water at an aseptic processing component to produce a dilute fluid. Thereby a sterile mixing process can be performed using a concentrate and a diluent, making use of an energy efficient process for sterilization of the diluent while maintaining a sterility requirement for the resulting mixture.

### BRIEF DESCRIPTION OF THE FIGURES

Illustrative examples of the present teachings will be described hereunder with reference to the accompanying Figures, in which:

FIG. 1 shows a schematic representation of an aseptic processing line according to a first example;

FIG. 2 shows a schematic representation of a multi-stage filter which may be deployed in the example of FIG. 1;

FIG. 3 shows a schematic representation of a high temperature sterilization which may be deployed in the example of FIG. 1;

FIG. 4a shows a schematic representation of an aseptic sterile process for a low acid concentrate;

FIG. 4b shows a schematic representation of an aseptic sterile process for a high acid concentrate;

FIG. 4c shows a schematic representation of an aseptic sterile process for a low acid concentrate; and

FIG. 4d shows a schematic representation of an aseptic sterile process for a high acid concentrate.

While the presently described approach is susceptible to various modifications and alternative forms, specific embodiments are shown by way of example in the drawings and are herein described in detail. It should be understood, however, that drawings and detailed description thereto are not intended to limit the scope to the particular form disclosed, but on the contrary, the scope is to cover all modifications, equivalents and alternatives falling within the spirit and scope as defined by the appended claims.

### DETAILED DESCRIPTION

As is illustrated in the accompanying Figures, the present teachings relate to approaches for creating am aseptic processing line which may be used to prepare a sterile beverage or foodstuff. The present teachings address the production of aseptic products while both controlling energy consumption in a sterilization process and maintaining sterility through aseptic connections. It will be appreciated that the claimed scope is not intended to be limited in any way by these examples.

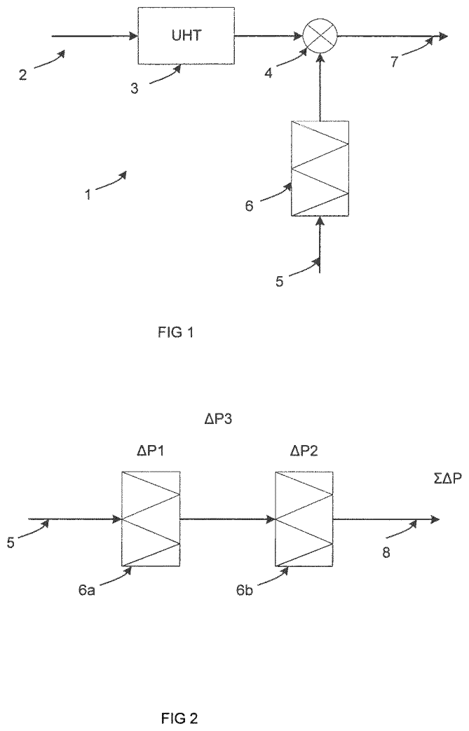

Such an approach is schematically illustrated in FIG. 1. In this figure, there is shown an aseptically connected dilute food or beverage fluid creation system 1. A concentrate, such as a beverage concentrate or a nutrition concentrate, is fed into the system via a concentrate inlet 2. This concentrate is then fed to a UHT (ultra-high temperature) sterilizer 3 to create sterile concentrate. The UHT sterilizer may be an indirect UHT sterilizer or a direct UHT sterilizer. The sterile concentrate is then fed to an aseptic mixing component 4.

In another inlet path, water enters via a water inlet 5 and is passed to a sterile filter 6. The water received at the water inlet 5 is, in the present examples any source of potable water. Potable water, for the present purposes is any water source deemed fit to drink and possible sources of potable water may include: water purified via reverse osmosis, distillation, or UV filtering and water treated within municipal water systems. The sterile water output from the sterile filter 6 is then also fed to the aseptic mixing component 4. The sterile filter 6 may be termed a cold water filter or cold sterilizer as it does not involve heating of the water passing therethrough to provide the sterilizing effect. The sterile filter 6 may also be termed a non-thermal sterilizer as the sterilization process performed is not predicated upon thermal treatment of the water. It is not excluded that some heating of the water may occur, for example due to energy changed caused by flow resistance and/or pumping, but any such heating is incidental to the sterilization process. The output of the aseptic mixing component 4 is therefore a dilute sterile fluid formed by diluting the concentrate with sterile water under aseptic conditions, and this dilute sterile fluid then exits the system at sterile dilute fluid outlet 7. Dilute sterile fluid provided at the output 7 can be taken for further processing, such as storage and/or packaging.

Examples of packaging that a foodstuff or beverage produced by this approach may be subjected to include packaging into bottle, cartons, cans, cups, bags, foil pouches etc. To this end, a packaging plant or apparatus may include an aseptic filling connector for establishing a sterile filling connection with such a packaging container. Thereby the packaging container may have the dilute fluid foodstuff or beverage passed there into while maintaining the sterile conditions from the food or beverage production stages of the apparatus.

From this example, it can therefore be seen that a sterile dilute fluid can be produced from separate sterile concentrate and sterile diluent streams that are mixed under aseptic conditions.

The concentrate may take many forms and may be a concentrate for a foodstuff or a beverage. Example ingredients that may individually or severally appear in such a concentrate include coffee extracts, tea extracts, milk extracts, juice extracts, dehydrated foodstuffs, colorants, flavorings, nutritional elements, proteins, carbohydrates, lipids, emulsifiers, stabilizers, and/or buffers. In the case of beverage production, it is envisaged that the concentrate may be a beverage concentrate that is either fully or partially diluted by the aseptic processing line to provide either a ready to drink beverage product or a beverage concentrate product for further dilution at point of sale or point of use. Beverages may include coffee-based beverages, tea-based beverages, milk-based beverages, juice-based beverages, energy beverages, flavored waters or the like. In the case of foodstuff production, it is envisaged that the concentrate may be a paste, puree, partially dehydrated or dehydrated foodstuff concentrate that is either fully or partially diluted or rehydrated by the aseptic processing line to provide a ready to eat foodstuff or a foodstuff ingredient. Ready to eat foodstuffs may include soups, stews, stocks, sauces, trek food meals or the like, and foodstuff ingredients may include pie fillings, meat or vegetable stock concentrates, vegetable concentrates or the like. In the context of this teaching, it is to be understood that the term concentrate does not necessarily take the literal meaning of a thing which has been concentrated but additionally refer more generally to collections of ingredients that are intended to be diluted before consumption.

One implementation using the system 1 of this example, the system may be used for dilution of a milk-based concentrate with water, where the concentrate and water are mixed in a 3:7 ratio with a total dilute sterile milk-based beverage output of 12,000 kg per hour. Accordingly, the concentrate input flow rate will be 3,600 kg per hour and the water input flow rate will be 8,400 kg per hour. Across the food and drink industry, typical throughput rates of UHT sterilization systems are in the range of 3,000 to 35,000 kg per hour. The present approach based on non-thermal filtration is operable to work at fluid throughput rates within this range.

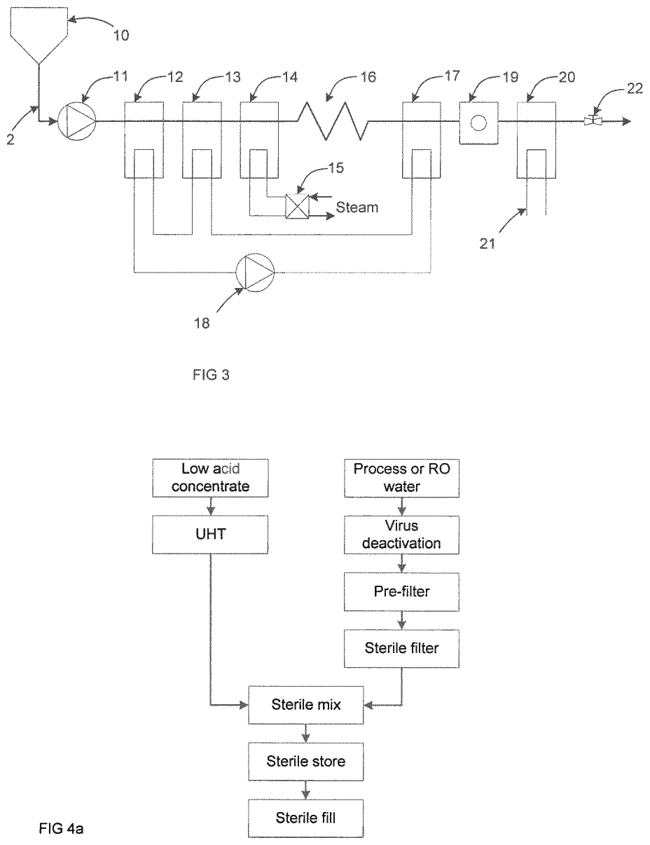

Depending on the nature of the water source from which the water inlet 5 is fed, the filtering may include a number of different steps or stages. In the present example, the water fed to the inlet is assumed to be free of large size particles but not to have been sterilized for drinking purposes. An example structure of the sterile filter 6 as used for water filtration is illustrated schematically in FIG. 2. As shown, the water inlet 5 receives the input water and this water is passed to a first filter stage 6a in the form of a 0.2 micron filter. The water output by the first filter stage 6a is then passed to a second filter stage 6b which is also in the form of a 0.2 micron filter. The water passing out of the second filter stage 6b then leaves via sterile line 8 which carries the sterile water onward toward the aseptic mixing component 4. Such a filtration process meets recognized levels of filtration pore size to effectively remove microorganisms (other than viruses) from the water passing through.

As will be appreciated, although the example discussed with reference to FIG. 2 mentions two filter stages each being a 0.2 micron filter, other filter sterilization structures may be employed. Indeed a single stage filter may be used, or where multiple filter stages are used they need not have the same maximum pore size. In general, any filter sterilization structure may be used where the filter pore size is sufficiently small to remove microorganisms. In the case where very small microorganisms such as viruses may not be excluded by the pore size, the filter can additionally include or be supplemented by an alternative virus removal or denaturing process, such as UV sterilization.

As will be appreciated, such filtration results in a pressure drop over the filter. The example filter illustrated in FIG. 2 causes a pressure drop in each stage 6a and 6b (i.e. ΔP1 and ΔP2). In addition there is a pressure drop caused by the connection lines (ΔP3). These individual pressure drops sum to provide a total pressure drop ΣΔP through the micron filtration stages. Thus there is necessarily an energy input required to drive the water through the filter stages. This pressure drop, once known is then factored into the flow delivery design of the overall system to provide that the mixing by the aseptic mixing component results in the achieved dilution ratio being sufficiently close to a target dilution ratio. As will be appreciated, alternative filter designs way result in a different pressure drop, which once measured or calculated can be taken into account in the overall system design in the same way. As will be discussed below, further filtration or treatment stages for the water may be implemented to account for the expected state of the water as fed into the system.

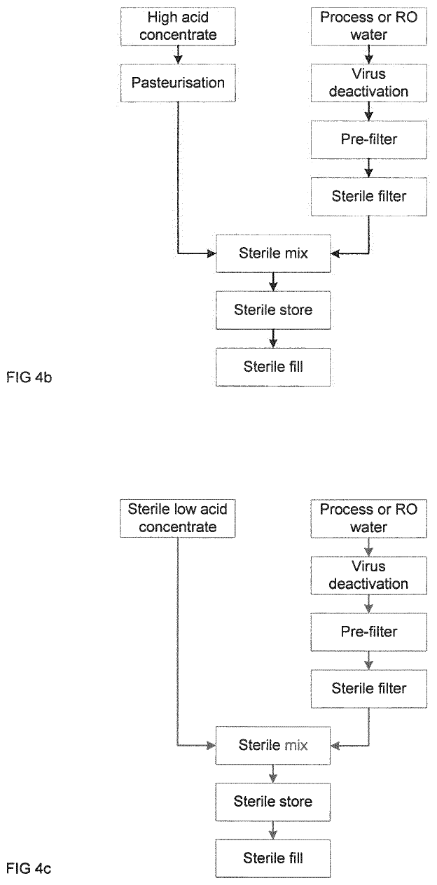

FIG. 3 illustrates in schematic format a UHT sterilization process suitable for use as the UHT sterilizer 3 (see FIG. 1). As shown, concentrate from a concentrate input vessel 10 is carried via the concentrate input 2 to arrive at the first stage of the UHT sterilizer 3. This first stage of the UHT sterilizer 3 is a pump 11 used to push the concentrate through the sterilizer. The concentrate then passes through first and second stage pre-heaters 12 and 13 which use recovered heat from the cooling stages to pre-heat the concentrate before the pre-heated concentrate arrives at heater 14. Heater 14 uses heat extracted from a steam supply using a heat exchanger 15 to further heat the pre-heated concentrate to a temperature of 140° C. The heated concentrate is then held at the temperature of 140° C. for at least 3 seconds in hold tube 16. As is known to those skilled in UHT processing, the 140° C./3 seconds figures are an accepted minimum heat duration to provide sterilization for low acid products. As will be appreciated, the absolute temperature reached and the hold duration can be altered to suit any other requirement for temperature and duration that may be applied to the system in use.

Once the temperature hold has completed a pre-cooler 17 is used to start cooling the now-sterile concentrate back to an acceptable temperature for further processing after sterilization. The pre-cooler 17 is connected to the pre-heaters 12 and 13 and a heat transfer fluid is pumped around the energy recover loop so-formed by a pump 18. Although such an energy recover loop is not an essential component of UHT processing, use of such a loop facilitates energy efficiency be re-using some of the heat extracted from the sterile concentrate after the temperature hold has completed to use for pre-heating the incoming concentrate prior to reaching the temperature hold. In some examples, use of such an energy recovery loop may achieve a heat recovery rate of up to 80%.

Once the part-cooled sterile concentrate exits the pre-cooler 17 it is passed to a homogenizer 19. The homogenizer operates to break down small particles and/or fat droplets to result in a physically stable product through shelf life.

Then, for final cooling, the homogenized part-cooled sterile concentrate passes to final cooling stage 20 which then extracts the remaining heat necessary to be able to pass the sterile concentrate on to subsequent processing. The final stage cooler 20 is fed with cooling water 21.

The final part of the UHT sterilizer of the present example is a valve 22 which can be operated to control system pressure.

As will be appreciated, the various modules 12, 13, 14, 17 and 20 illustrated as heat exchangers in FIG. 3 can be formed by any suitably designed heat exchanger structure. As will also be appreciated, all of the components downstream of the hold tube 16 are configured and connected as aseptic components with aseptic interconnections to maintain the sterility of the UHT treated concentrate.

As will be understood from the discussion above, such UHT processes are rather energy intensive as they requires the use of large amounts of electricity for large motors, steam for heating, compressed air for operating valves automatically, and often significant amounts of cooling. Many food and beverage products require homogenization in order to give a product that has the necessary physical stability (no creaming off and no sedimentation) throughout the desired shelf-life. Homogenization is itself a very energy intensive process, often requiring more than 20 kJ of energy per kg of product. Even if deploying techniques for energy saving such as using heat recovery from the cooling stages to pre-heat the heating stages, a UHT process as illustrated with respect to FIG. 3 still consumes large quantities of energy and the energy saving methodologies such as heat recovery come at the cost of more complexity, thus further adding to the installed costs of such systems. Cooling plant in particular is typically large, materials intensive, expensive to install and has high energy requirements to run.

As will be appreciated, although there is an energy requirement to drive the water through the filter sterilization equipment, this is significantly lower than the energy required to sterilize that same quantity of water by UHT or even pasteurization. Water is typically the main ingredient in beverages produced from concentrate, and also a major ingredient in foodstuffs produced from food concentrates such as fully or partially dehydrated ingredients. For example, in many processing lines water comprises at least 50% of the ingredient amount (often in the range of 50%-60% for beverages to be provided as concentrates for consumer dilution and often as much as 90% or more (up to 95% or 99% in some cases) for some ready to drink products such as unsweetened tea and coffee drinks). Therefore, the presently taught approach of removing the UHT energy requirements from the water sterilization while maintaining the necessary levels of water treatment has the potential to significantly reduce the overall power consumption of such beverage or foodstuff preparation lines. Thus, even where UHT processing is used (as illustrated with respect to FIG. 1) for the treatment of a beverage concentrate, the energy required for UHT processing of the concentrate is far below that required to UHT sterilize all of the prepared beverage content. In addition to the energy cost of UHT systems, such systems are typically also very large, materials intensive and expensive to obtain, install and configure. In contrast, a micron filter system, as proposed in the description above is typically rather smaller, uses less material in its construction per throughput capability and less expensive to acquire as well as operate. Thus, with particular reference to the context of the food and beverage processing industry, where operational margins are typically small, it will be seen that the present teachings facilitate the creation or expansion of plant capacity with reduced capital and materials intensity, and in such a way as to have reduced ongoing operating demands.

The system shown in FIG. 1 has been compared to a conventional system in which a beverage concentrate and water are first mixed and then the mixed beverage is sterilized prior to bottling by a UHT sterilization process. In this comparison, the system in accordance with the present teachings follows the above-mentioned example of dilution of a milk-based concentrate with water, where the concentrate and water are mixed in a 3:7 ratio with a total dilute sterile milk-based beverage output of 12,000 kg per hour. Thus in the system of the present example, the UHT sterilizer will correspondingly treat only the 3,600 kg per hour while the 8400 kg per hour of water will be sterilized by filtration. This in combination was calculated to consume 139 kW of energy, in the form of 3.48 kW of electrical energy (to power pumps etc) and 136 kW of steam energy (used for heating in the UHT process for the concentrate).

In comparison, the conventional system of mixing before sterilization results in the entire 12,000 kg per hour of mixed beverage being subject to the UHT treatment. This conventional approach was calculated to consume 740 kW of energy, in the form of 5.03 kW of electrical energy and 735 kW of steam energy.

Based on this calculation, it was determined that for the production of the example milk-based drink from concentrate, the system of the present examples would use around 20% of the total energy, and incur only around 25% of the operational energy cost of operating the conventional system for production of the example beverage. Looking at the comparison from an energy efficiency point of view, the carbon footprint (tons of CO₂ produced) of the system of the present examples was calculated to be only around 20% of the carbon footprint of the conventional system. As will be appreciated, exact determination of carbon footprint is a complex matter that will depend upon the particular circumstance of each individual implementation. However, it is seen that the fact that systems according to the present teachings can be implemented by way of physically smaller equipment that use less operating energy than conventional systems, leading to a significantly reduced carbon footprint.

Illustratively, therefore it will be understood that an energy saving of around 20% could be achieved by adopting sterilization according to the presently disclosed techniques in place of UHT processing. It is noted that for a large global milk-based beverage manufacturer, production of the type used for this example can be around 200 million kg of processed beverage per year. It is further noted that more broadly an estimated annual global production of 2.4 billion kg of processed beverage could be performed using the presently disclosed techniques. If such techniques were adopted for a production volume of 2.4 billion kg of processed beverage, it is estimated that this could result in a carbon footprint reduction of around 36,000 tons per year.

Thus it will be understood that by adopting a lower energy cost filtration sterilization approach for the sterilization of the water for use as diluent in combination with adopting a sterile mix process through use of an aseptic mixing component to combine the filter sterilized water with a thermal-treated beverage concentrate so as to maintain sterility, a low energy impact approach can be implemented while not compromising on the compliance with sterility and food safety considerations.

Although it has been described above that the sterilization of the concentrate is performed by way of UHT sterilization, other hot process sterilization approaches may be used. For example, a pasteurization process may be used in place of the UHT sterilization. Other approaches to such sterilization of the concentrate may not necessarily utilize hot-sterilization processes, such non-thermal alternatives include radiation sterilization (such as by ionizing radiation such as gamma or electron beam sterilization), filter sterilization, high pressure sterilization, electric field pulse sterilization, or combinations thereof.

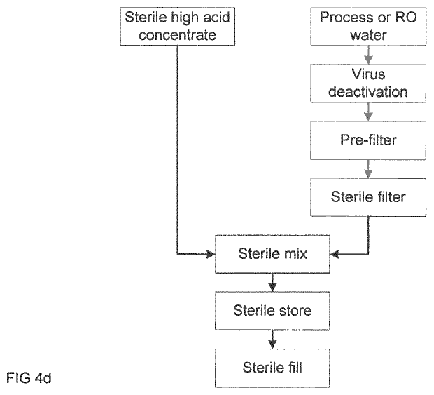

As will be appreciated, a variety of different concentrates may be used to produce a variety of diluted products. These include concentrates for beverages such as coffee-based drinks, tea-based drinks, milk-based drinks, juice-based drinks, nutrition-supplement drinks and combinations of these (e.g. combined coffee and milk drinks, combined juice and nutrition drinks or combined nutrition and milk drinks). In addition, the concentrates may include additional additives such as sweeteners, non-nutritive sweeteners, colorings, vitamins, minerals, other nutritional substances or the like. A number of examples of process structures that can be used to create such dilute drinks from concentrate in accordance with the present teachings will now be described with reference to FIGS. 4a to 4d. In the context of the present teachings, high acidity concentrates have a ph that is less than 4.6, while low-acid concentrates have a pH greater than 4.6.

FIG. 4a illustrates an example process for producing a beverage from a low acid beverage concentrate (for example a milk-based concentrate or a coffee-based concentrate). In this example, the beverage concentrate path includes a UHT sterilization, which may follow the form illustrated with respect to FIG. 3 above. On the other hand, the water path includes an input of process water or reverse osmosis water which is subjected to virus deactivation (for example by ultraviolet light or direct electrical discharge) then a pre-filter before the sterile filtration. As discussed above, the virus deactivation stage may be omitted if the sterile filter has a pore size small enough to remove viruses from the water. The pre-filter serves to remove particle contaminants in the water. As will be appreciated, water that has been coarse-filtered to remove large particulates may still contain particulates sufficiently large to cause clogging and flow inefficiencies of the sterile filter (which as discussed above has a pore size small enough to remove potentially harmful micro-organisms) and thus one or more pre-filters with a larger pore size than the micron filter may be implemented to remove small particles. In one example, the pre-filter may have a pore size in the region of 45 microns, but other filter sizes may be used instead or in addition. The sterile filter may be a single or multi-stage filtration and may follow the form illustrated with respect to FIG. 2 above. Following the mixing under sterile conditions of the sterilized water and the sterilized concentrate by an aseptic mixing component the mixed beverage may be stored and then bottled, each under sterile conditions.

FIG. 4b illustrates an example process for producing a beverage from a high acid beverage concentrate (for example a tea-based concentrate). In this example, the beverage concentrate path includes a pasteurization sterilization. It is noted however that both low acid and high acid concentrates may be subjected to either UHT sterilization or pasteurization, depending upon the particular requirements of the concentrate and finished beverage or foodstuff. On the other hand, the water path includes an input of process water or reverse osmosis water which is subjected to virus deactivation (for example by ultraviolet irradiation) then the pre-filter before the sterile filtration. As discussed above, the virus deactivation stage may be omitted if the sterile filter has a pore size sufficient to remove viruses. The pre-filter serves as discussed above to remove particle contaminants in the water. The sterile filter may be a single or multi-stage filtration and may follow the form illustrated with respect to FIG. 2 above. Following the mixing under sterile conditions of the sterilized water and the sterilized concentrate by an aseptic mixing component the mixed beverage may be stored and then bottled, each under sterile conditions.

FIG. 4c illustrates an example process for producing a beverage from a sterile low acid beverage concentrate (for example a milk-based concentrate or a coffee-based concentrate). In this example, the beverage concentrate path includes an aseptic path from a source of the sterile concentrate to the mix stage. On the other hand, the water path includes an input of process water or reverse osmosis water which is subjected to virus deactivation (for example by ultraviolet irradiation) then a pre-filter before the sterile filtration. As discussed above, the virus deactivation stage may be omitted if the sterile filter has a pore size sufficient to remove viruses. The pre-filter serves as discussed above to remove particle contaminants in the water. The sterile filter may be a single or multi-stage filtration and may follow the form illustrated with respect to FIG. 2 above. Following the mixing under sterile conditions of the sterilized water and the sterile concentrate by an aseptic mixing component the mixed beverage may be stored and then bottled, each under sterile conditions.

FIG. 4d illustrates an example process for producing a beverage from a high acid beverage concentrate (for example a tea-based concentrate). In this example, the beverage concentrate path includes an aseptic path from a source of the sterile concentrate to the mix stage. On the other hand, the water path includes an input of process water or reverse osmosis water which is subjected to virus deactivation (for example by ultraviolet irradiation) then the pre-filter before the sterile filtration. As discussed above, the virus deactivation stage may be omitted if the sterile filter has a pore size sufficient to remove viruses. The pre-filter serves as discussed above to remove particle contaminants in the water. The sterile filter may be a single or multi-stage filtration and may follow the form illustrated with respect to FIG. 2 above. Following the mixing under sterile conditions of the sterilized water and the sterilized concentrate by an aseptic mixing component the mixed beverage may be stored and then bottled, each under sterile conditions.

Thus it will be seen that a sterile beverage production approach may use a variety of concentrate sources and types and uses such a concentrate, after any necessary sterilization thereof, to combine with filter-sterilized water under aseptic conditions so as to provide a sterile dilute beverage at a low energy cost.

Although it has been described above that the foodstuff or beverage preparation process uses water that is sterilized by filter sterilization before aseptic mixing with sterile concentrate or other ingredients, other approaches may use an alternative diluent. For example the diluent may be water with additional ingredients already added, such additional ingredients may, for example, include vitamins, flavors or sweeteners. Alternatively, the diluent may be or include a potable diluent or consumable liquid other than water, such as sugar syrup, sweetener, acids and/or flavors.

Although it has been described above that the low energy water sterilization is provided by way of sterile filtrations, in some implementations the water sterilization may be performed for example by ozone-based sterilization. Thus may be appropriate in instances where facilities for maintenance and/or replacement of physical filter membranes are unavailable. It is recognized that in some instances ozone sterilization may be of reduced applicability due to the possibility of ozone reacting with substances in the concentrate or due to a need to use supplementary particle filters due to known particulate contamination of the water supply.

Although it has been described above with reference to FIG. 1 that the sterilization of diluent and concentrate take place in the same plant installation, the present teachings also encompass a situation where a sterile concentrate is provided directly into the processing plant. In such an example, the plant has an aseptic connection input for the sterile concentrate, which concentrate will have been previously sterilized and packaged under aseptic conditions into a sterile concentrate transport packaging container (such as a bottle, carton, bag, pouch or the like). The processing plant then mixes the sterile concentrate as received via the aseptic connection input with the sterile diluent from the cold sterilizer to produce the dilute sterile fluid for output.

Therefore, from one perspective, there has been described an approach for energy efficient creation of dilute sterile fluids such as ready-to-drink beverages. To achieve such creation, a beverage processing apparatus may have a sterile liquid concentrate source connected to deliver sterile liquid concentrate and a sterile water source having an inlet connected to receive water and a cold water filter sterilizer connected to the inlet. The apparatus may also have a dilute fluid outlet and an aseptic mixing component. The aseptic mixing component may be interconnected between the sterile liquid concentrate source, the sterile water source and the dilute fluid outlet to: receive sterile liquid concentrate; receive sterile water; and to provide a dilute fluid.

In one embodiment of the present invention, an aseptic black coffee beverage has been produced under the conditions of: 20% heat sterilized concentrate mixed with 80% filter sterilized water. The final mixed product by this approach was demonstrated to meet all the specifications of the same product aseptically processed as a fully formulated product, and meets all the requirements for commercial production.

In another embodiment of the present invention, an aseptic black coffee beverage has been produced under the conditions of: 60% heat sterilized concentrate mixed with 40% filter sterilized water. The final mixed product by this approach was demonstrated to meet all the specifications of the same product aseptically processed as a fully formulated product, and meets all the requirements for commercial production.

In one embodiment of the present invention, an aseptic coffee beverage with dairy ingredients and other food additives has been produced under the conditions of: 30% heat sterilized concentrate mixed with 70% filter sterilized water. The final mixed product by this approach was demonstrated to meet all the specifications of the same product aseptically processed as a fully formulated product, and meets all the requirements for commercial production.

In another embodiment of the present invention, an aseptic coffee beverage with the dairy ingredients and other food additives has been produced under the conditions of: 40% heat sterilized concentrate mixed with 60% filter sterilized water per the described approach. The final mixed product by this approach was demonstrated to meet all the specifications of the same product aseptically processed as a fully formulated product, and meets all the requirements for commercial production.

In one embodiment of the present invention, an aseptic coffee beverage with the dairy and cocoa ingredients and other food additives has been produced under the conditions of: 60% heat sterilized concentrate mixed with 40% filter sterilized water per the described approach. The final mixed product by this approach was demonstrated to meet all the specifications of the same product aseptically processed as a fully formulated product, and meets all the requirements for commercial production.

A microbiological validation study documented that the sterile water system can maintain sterile conditions, continuously, for no less than 88 hours.

Further examples and feature combinations consistent with the present teachings are set out in the following numbered clauses:

Clause 1. Apparatus comprising: a sterile liquid concentrate source; a non-thermally sterilized potable diluent source; a dilute fluid outlet; and an aseptic mixing component connected: to the sterile liquid concentrate source to receive sterile liquid concentrate therefrom; to the non-thermally sterilized potable diluent source to receive sterile potable diluent therefrom; and to the dilute fluid outlet to provide a dilute fluid thereto.

Clause 2. The apparatus of clause 1, wherein the sterile liquid concentrate is a water-based concentrate comprising at least one dissolved ingredient, where the at least one ingredient comprises one or more selected from the group comprising: a colorant; a flavoring; a nutritional element; a protein; a carbohydrate; a lipid; an emulsifier; a stabilizer; and a buffer.

Clause 3. The apparatus of clause 1 or 2, wherein the concentrate is a food or beverage concentrate.

Clause 4. The apparatus of clause 1, 2 or 3, wherein the non-thermally sterilized potable diluent source comprises: a non-thermal water sterilizer or an ozone sterilizer connected to a water source.

Clause 5. The apparatus of clause 5, wherein the non-thermal water sterilizer comprises a filter sterilizer.

Clause 6. The apparatus of clause 4 or 5, wherein the non-thermal water sterilizer comprises a single stage or multi-stage filtration sterilizer.

Clause 7. The apparatus of clause 4, 5 or 6, wherein the non-thermal water sterilizer further comprises an ultraviolet sterilizer or direct electrical discharge sterilizer.

Clause 8. The apparatus of any of clauses 4 to 7, wherein the water source comprises a reverse osmosis water source or a potable water source.

Clause 9. The apparatus of any of clauses 1 to 8, wherein the sterile liquid concentrate source comprises one or more selected from the group comprising: a sterilizer connected to a liquid concentrate source; and an aseptic input connector configured to receive concentrate from a sterile concentrate packaging container.

Clause 10. The apparatus of clause 9, wherein the sterilizer comprises one or more selected from the group comprising: a hot sterilizer such as a direct UHT sterilizer; an indirect UHT sterilizer; or a pasteurizer; and a non-thermal sterilizer such as a radiation sterilizer, a filter sterilizer, a high pressure sterilizer, or an electric field pulse sterilizer.

Clause 11. The apparatus of any of clauses 1 to 10, wherein the dilute fluid outlet comprises a packing or filling plant.

Clause 12. The apparatus of clause 10, wherein the packing or filling plant comprises an aseptic filling connector for passing the dilute fluid into one or more selected from the group comprising: a bottle; a carton; a can; a cup; a pouch and a bag.

Clause 13. The apparatus of any of clauses 1 to 12, wherein the aseptic mixing component is connected to provide continuity of sterility for the sterile liquid concentrate and sterile potable diluent to provide a sterile dilute fluid to the dilute fluid outlet.

Clause 14. An aseptic processing line in a food or beverage processing plant, comprising: a concentrate component; a non-thermal diluent sterilizer; and an aseptic downstream processing component; wherein concentrate from the concentrate component is mixed with diluent form the non-thermal diluent sterilizer.

Clause 15. The processing line of clause 14, wherein the concentrate component provides a hot sterilized water-based liquid concentrate to the aseptic downstream processing component.

Clause 16. The processing line of clause 14 or 15, wherein the non-thermal sterilizer provides sterile water to the aseptic downstream processing component for use as a diluent.

Clause 17. The processing line of clause 14, 15 or 16, wherein the sterile non-thermal sterilizer produces sterile water by cold sterilization.

Clause 18. The processing line of any of clauses 14 to 17, wherein the aseptic downstream component outputs a mixed sterile food or beverage fluid to a processing plant.

Clause 19. The processing line of any of clauses 14 to 18, further comprising a concentrate input configured to receive at least one water-soluble ingredient selected from the group comprising: a colorant; a flavoring; a nutritional element; a protein; a carbohydrate; a lipid; an emulsifier; a stabilizer; and a buffer.

Clause 20. A method of diluting a concentrate comprising: feeding a sterile liquid concentrate from a sterile liquid concentrate source; feeding sterile diluent from a cold-sterilized diluent source; and combining the sterile liquid concentrate and sterile diluent at an aseptic processing component to produce a dilute fluid.

Clause 21. The method of clause 20, wherein the concentrate is a water-based concentrate comprising at least one dissolved ingredient, where the at least one ingredient comprises one or more selected from the group comprising: a colorant; a flavoring; a nutritional element; a protein; a carbohydrate; a lipid; an emulsifier; a stabilizer; and a buffer.

Clause 22. The method of clause 20 or 21, wherein the concentrate is a food or beverage concentrate.

Clause 23. The method of clause 20, 21 or 22, further comprising creating the cold-sterilized diluent source by: feeding water to a sterilizer; and sterilizing the water at the sterilizer by a process of cold water sterilization.

Clause 24. The method of clause 23, wherein the process of cold water sterilization comprises filter sterilization.

Clause 25. The method of clause 23 or 24, wherein the process of cold water sterilization comprises single or multi-stage filtration.

Clause 26. The method of clause 23, 24 or 25, wherein the process of cold water sterilization further comprises ultraviolet sterilization or direct electrical discharge sterilization.

Clause 27. The method of any of clauses 23 to 26, wherein the feeding water comprises feeding water from a reverse osmosis water source or a potable water source.

Clause 28. The method of any of clauses 20 to 27, further comprising creating the sterile concentrate source by one or more selected from the group comprising: feeding concentrate to a sterilizer, and sterilizing the concentrate at the sterilizer by a process of hot sterilization; and connecting a container of sterile concentrate to an aseptic input connector.

Clause 29. The method of clause 28, wherein the process of hot sterilization comprises one or more selected from the group comprising: direct UHT sterilization; indirect UHT sterilization; and pasteurization.

Clause 30. The method of any of clauses 20 to 29, further comprising packaging the dilute fluid.

Clause 31. The method of clause 30, wherein the packaging comprises passing the dilute fluid through an aseptic filling connector into one or more selected from the group comprising: a bottle; a carton; a can; a cup; a pouch and a bag.

Clause 32. The method of any of clauses 20 to 31, wherein the aseptic processing component is arranged to provide continuity of sterility for the sterile concentrate and sterile water to provide a sterile dilute fluid.

Although the present teachings have been described by way of example in language specific to structural features and/or methodological acts, it is to be understood that the scope defined in the appended claims is not necessarily limited to the specific features or acts described. Rather, the specific features and acts are disclosed as example forms of implementing methods, systems and approaches consistent with the appended claims. It should be appreciated that variations and modifications may be made without departing from the scope as defined in the claims. Furthermore, where known equivalents exist to specific features, such equivalents are incorporated as if specifically referred in this specification

Any reference to prior art in this specification is not to be considered an admission that such prior art is widely known or forms part of the common general knowledge in the field.

As used in this specification, the words “comprises”, “comprising”, and similar words, are not to be interpreted in an exclusive or exhaustive sense. In other words, they are intended to mean “including, but not limited to”.

1. Apparatus comprising:
a sterile liquid concentrate source;
a non-thermal sterilizer connected to a diluent source;
a dilute fluid outlet; and
an aseptic mixing component connected:
to the sterile liquid concentrate source to receive sterile liquid concentrate therefrom;
to the non-thermal sterilizer to receive sterile diluent therefrom; and
to the dilute fluid outlet to provide a dilute fluid thereto.

2. The apparatus of claim 1, wherein the sterile liquid concentrate is a food or beverage concentrate, wherein the concentrate is food ingredient water-based concentrate comprising at least one dissolved ingredient, where the at least one ingredient comprises one or more selected from the group consisting of: a colorant; a flavoring; a nutritional element; a protein; a carbohydrate; a lipid; an emulsifier; a stabilizer; and a buffer.

3. The apparatus of claim 1, wherein the non-thermal sterilizer comprises a filter sterilizer.

4. The apparatus of claim 1, wherein the non-thermal sterilizer comprises a single or multi-stage filtration sterilizer.

5. The apparatus of claim 1, wherein the non-thermal sterilizer further comprises an ultraviolet sterilizer or direct electrical discharge sterilizer.

6. The apparatus of claim 1, wherein the water source comprises a potable water source.

7. The apparatus of claim 1, wherein the sterile liquid concentrate source comprises one or more selected from the group consisting of:
a sterilizer connected to a liquid concentrate source; and
an aseptic input connector connected to receive concentrate from a sterile concentrate packaging container connected to said input connector.

8. The apparatus of claim 7, wherein the sterilizer comprises one or more selected from the group consisting of: a hot sterilizer and a non-thermal sterilizer.

9. The apparatus of claim 7, wherein the sterilizer comprises one or more selected from the group consisting of: a direct UHT sterilizer; an indirect UHT sterilizer; a pasteurizer, a radiation sterilizer, a filter sterilizer, a high pressure sterilizer, and an electric field pulse sterilizer.

10. The apparatus of claim 1, wherein the dilute fluid outlet comprises or is connected to a sterile filling plant.

11. The apparatus of claim 10, wherein the sterile filling plant comprises an aseptic filling connector for establishing a sterile filling connection with one or more selected from the group comprising: a bottle; a carton; a can; a cup; a pouch and a bag.

12. The apparatus of claim 1, wherein the aseptic mixing component is connected to provide continuity of sterility for the sterile liquid concentrate and sterile water to provide a sterile dilute fluid to the dilute fluid outlet.

13. A beverage or food processing apparatus for dilution of a beverage or food concentrate, the apparatus comprising:
a sterile liquid concentrate source connected to deliver sterile liquid concentrate;
a sterile potable diluent source comprising an inlet connected to receive potable diluent and a cold filter sterilizer connected to the inlet;
a dilute fluid outlet; and
an aseptic mixing component connected:
to the sterile liquid concentrate source to receive sterile liquid concentrate therefrom;
to the sterile potable diluent source to receive sterile potable diluent therefrom; and
to the dilute fluid outlet to provide a dilute fluid thereto.

14. A method of diluting a food or beverage concentrate comprising:
feeding a sterile liquid concentrate from a sterile liquid concentrate source;
producing sterile water by non-thermal sterilization; and
combining the sterile liquid concentrate and sterile water at an aseptic processing component to produce a dilute fluid.

15. The method of claim 14, wherein the concentrate is a water-based concentrate comprising at least one dissolved ingredient, where the at least one ingredient comprises one or more selected from the group consisting of: a colorant; a flavoring; and a nutritional element.

16. The method of claim 14, wherein the non-thermal sterilization comprises filter sterilization.

17. The method of claim 14, wherein the non-thermal sterilization comprises one or more selected from the group consisting of: single stage filtration; multi-stage filtration; ultraviolet sterilization; and direct electrical discharge sterilization.

18. The method of claim 14, further comprising creating the sterile concentrate source by one or more selected from the group consisting of:
feeding concentrate to a sterilizer, and sterilizing the concentrate at the sterilizer by a process of hot sterilization, wherein the process of hot sterilization comprises one or more selected from the group comprising: direct UHT sterilization; indirect UHT sterilization; and
pasteurization; and
connecting a sterile concentrate container to an aseptic input connector.

19. The method of claim 14, further comprising packaging the dilute fluid, wherein the packaging comprises passing the dilute fluid via an aseptic filling connector into one or more selected from the group comprising: a bottle; a carton; a can; a cup; a pouch and a bag.
